(19) United States
(12) Patent Application Publication
(10) Pub. No.: US 2015/0204136 A1
(43) Pub. Date: Jul. 23, 2015

(54) DROP DOWN WINDOW BLIND WITH UNOBSTRUCTED WINDOW VIEW

(71) Applicant: Gandhi Holdings Ltd., Victoria (CA)

(72) Inventors: Sarab GANDHI, Victoria (CA); Rajan GANDHI, Victoria (CA)

(21) Appl. No.: 14/600,213

(22) Filed: Jan. 20, 2015

(30) Foreign Application Priority Data
Jan. 20, 2014 (CA) 2839754

(51) Int. Cl. E06B 9/32

(52) U.S. Cl. CPC E06B 9/32

(57) ABSTRACT

A drop down window blind includes a first member having opposed ends and a second member having opposed ends. A foldable blind substrate is connected to the first member and the second member. The blind substrate unfolds during relative diverging movement of the first member and the second member and folds during relative converging movement of the first member and the second member. A first member cord extends from a drive unit through each of the opposed ends of the first member. Rotation of the drive unit in a first rotational direction decreases a length of the first member cord to move the first member in a first direction and rotation of the drive unit in a second rotational direction increases a length of the first member cord to move the first member in a second direction.

### FIELD

There is described a drop down window blind that does not have a window view obstructed by cords,

### BACKGROUND

With all conventional drop down window blinds, the view through the window is unavoidably obstructed by centrally positioned cords. Nien Made Enterprise Co Ltd, the manufacturer of Norman Window Fashions (U.S. Trademark Registration 3335709) brand of blinds, discloses one form of drop down window blind that provides a window view that is unobstructed by centrally positioned cords. There will hereinafter be described an alternative drop down window blind that will provides a window view unobstructed by centrally positioned cords,

### SUMMARY

There is provided a drop down window blind which includes a first member having opposed ends and a second member having opposed ends. The second member is disposed on a common plane with the first member. A foldable blind substrate is connected to the first member and the second member. The blind substrate unfolds during relative diverging movement of the first member and the second member. The blind substrate folds during relative converging movement of the first member and the second member. A drive housing is provided which houses at least one first member drive unit. A first member cord extends from the at least one first member drive unit through each of the opposed ends of the first member. Rotation of the first member drive unit in a first rotational direction decreases a length of the first member cord to move the first member in a first vertical direction and rotation of the first member drive unit in a second rotational direction increases a length of the first member cord to move the first member in a second vertical direction.

In many applications, it is not only desirable to be able to raise and lower the first member, it is also desirable to raise and lower the second member. In such situations, the drive housing houses at least one second member drive unit. A second member cord extends from the at least one second member drive unit through each of the opposed ends of the first member and down through the foldable blind substrate to the second member. Rotation of the second member drive unit in a first rotational direction decreases a length of the second member cord to move the second member in a first vertical direction. Rotation of the second member drive unit in a second rotational direction increases a length of the second member cord to move the second member in a second vertical direction.

There will hereinafter be described a number of different embodiments, based upon the fundamental principles set forth above.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a front elevation view, in section, of a first embodiment of window blind having a first cord with anchored ends and a second cord with anchored ends.

FIG. 2 is a front elevation view, in section, of a second embodiment of window blind having the anchored ends of the second cord crossed.

FIG. 3 is a front elevation view, in section, of a third embodiment of window blind having a first cord in an endless loop and the second cord with anchored ends.

FIG. 4 is a front elevation view, in section, of a fourth embodiment of window blind having the first cord in an endless loop and the anchored ends of the second cord crossed.

FIG. 5 is a front elevation view, in section, of a fifth embodiment of window blind having a first cord with anchored ends and a second cord in an endless loop.

FIG. 6 is a front elevation view, in section, of a sixth embodiment of window blind having a first cord with anchored ends and a second cord in an endless loop with the endless loop crossing itself.

FIG. 7 is a front elevation view, in section, of a seventh embodiment of window blind having a first cord and a second cord in an endless loop.

FIG. 8 is a front elevation view, in section, of an eighth embodiment of window blind having a first cord in an endless loop and a second cord in an endless loop with the endless loop crossing itself.

FIG. 9 is a is a front elevation view, in section, of further embodiments of window blind having a first cord with anchored ends, a second cord with anchored ends, a magnetic coupling, and retainer means variations.

FIG. 10 is a front elevation view, in section, of another embodiment of the present invention having pulls that may be hand manipulated.

### DETAILED DESCRIPTION

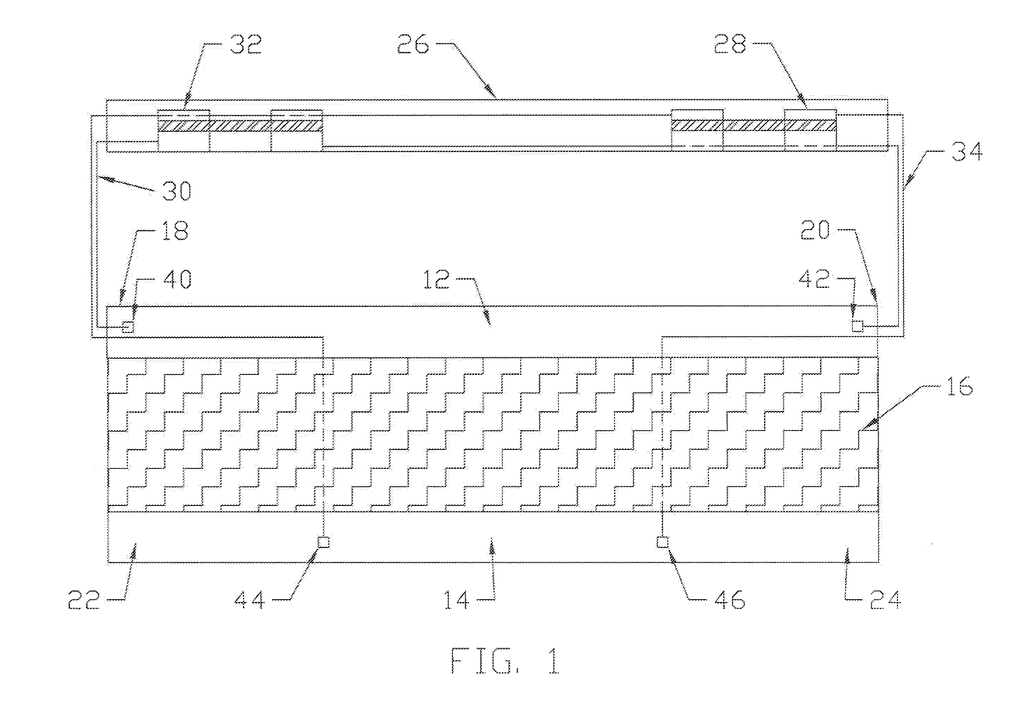

Related embodiments of drop down window blind will now be described with reference to FIG. 1 through FIG. 10.

### Common Elements in Most Embodiments

Referring to FIG. 1 through FIG. 10, there will first be described elements that are common to most of the embodiments shown therein. Each variation has a first member 12, a second member 14 and a foldable blind substrate 16, First member has opposed ends: first end 18 and second end 20. Second member 14 has opposed ends: first end 22 and second end 24. Second member 14 is disposed on a common plane with first member 12. What is meant by common plane, is that second member can be on a common vertical plane, common horizontal plane or common angular plane depending upon the nature of the installation. Most windows would tend to have a vertical orientation. However, skylights may call for a horizontal or angular orientation.

Blind substrate 16 is connected to first member 12 and second member 14. Blind substrate 16 unfolds during relative diverging movement of first member 12 and second member 14. Blind substrate 16 folds during relative converging movement of first member 12 and the second member.

A drive housing 26 houses a first member drive unit 32. A first member cord 30 extends from first member drive unit 32 through each of opposed ends 18 and 20 of first member 12. Rotation of first member drive unit 32 in a first rotational direction wraps cord onto first member drive unit 32 and decreases a length of first member cord 30 to move the first member 12 in a first direction. Rotation of first member drive unit 32 in a second rotational direction unwraps cord from first member drive unit 32 increasing a length of first member cord 30 to move first member 12 in a second direction.

Each embodiment of drop down window blind can function without similar control being exerted over second member 14. However, commercial acceptance typically requires control over second member 14. For that reason, for each embodiment drive housing 26 also houses a second member drive unit 28. A second member cord 34 extends from second member drive unit 28 through each of opposed ends 18 and 20 of first member 12 and down through foldable blind substrate 16 to second member 14. Rotation of second member drive unit 28 in a first rotational direction wraps cord onto second member drive unit 28 and decreases a length of second member cord 34 to move second member 14 in a first direction. Rotation of second member drive unit 28 in a second rotational direction unwraps cord from second member drive unit 28 and increases a length of second member cord 34 to move second member 14 in a second direction.

### Embodiment 1—FIG. 1

Referring to FIG, 1, a first end 40 of first member cord 30 enters and is secured to first end 18 of first member 12 and a second end 42 of first member cord 30 enters and is secured to first end 20 of first member 12. A first end 44 of second member cord 34 enters first end 18 of first member 12, extends down through foldable blind substrate 16 and attaches to second member 14 at a point spaced from first end 22. A second end 46 of second member cord 34 enters second end 20 of first member 12, extends down through the foldable blind substrate 16 and attaches to second member 14 at a point spaced from second end 24.

The above described embodiment 1, functions adequately. However, if care was not taken to configure each of the drive units to create an equal pull along the right side and left side, the first member or the second member can jam. A desire to address this problem of even pull to avoid jamming gave rise to the variations that will hereinafter be further described.

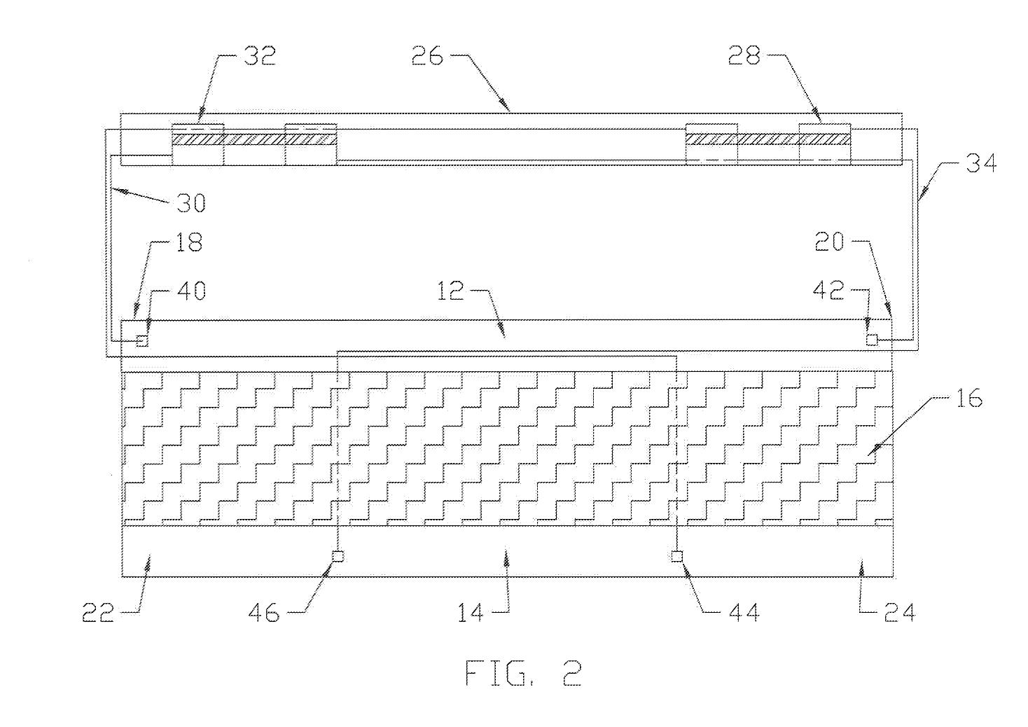

### Embodiment 2—FIG. 2

Referring to FIG. 2, the difference between what is illustrated in embodiment 1 and embodiment 2 is the “crossing” of second member cord 34. As with embodiment 1, first end 44 of second member cord 34 enters first end 18 of first member 12, and extends down through foldable blind substrate 16. However, first end 44 attaches to second member 14 at a point spaced from second end 24. Similarly, second end 46 of second member cord 34 enters second end 20 of first member 12, extends down through foldable blind substrate 16 and attaches to second member 14 at a point spaced from first end 22 of second member 14. It is to be noted that second member cord 34 entering first end 18 of first member 12 is secured to second end 24 of second member 14, while second member cord 34 entering second end 20 of first member 12 is secured to first end 22 of second member 14. It is this crossing that assists in creating an equal pull.

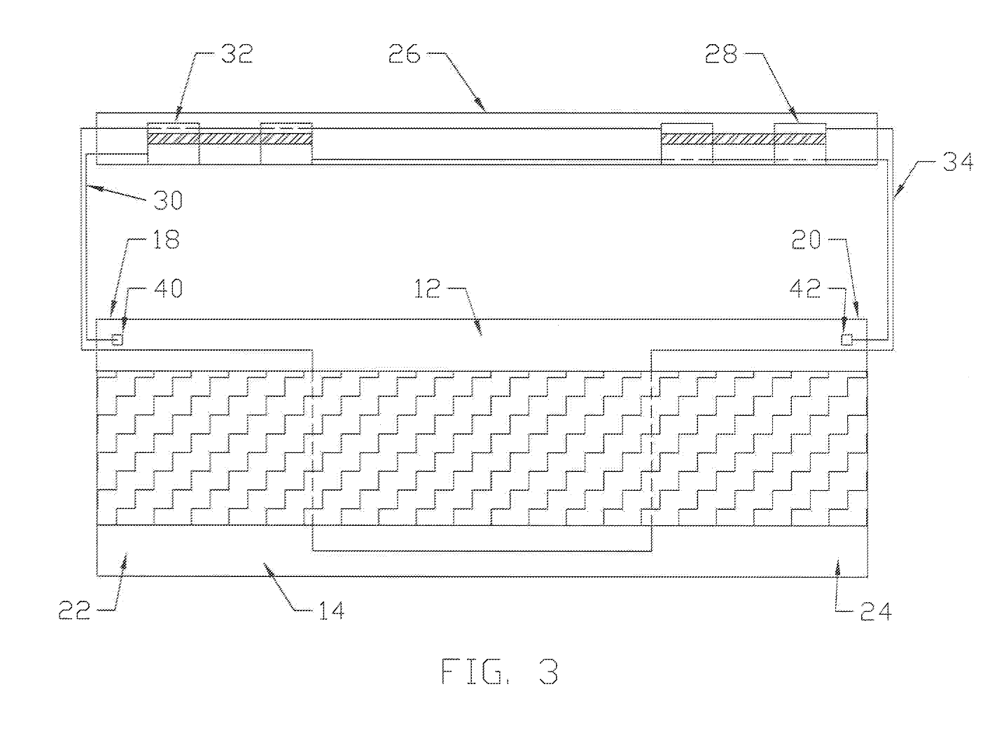

### Embodiment 3—FIG. 3

Referring to FIG. 3, there is illustrated an embodiment that was developed as an alternative to the crossing approach described with respect to FIG. 2. In this embodiment, second member cord 34 forms an endless loop. There being no specific end attachment points, the pull forces are more evenly distributed.

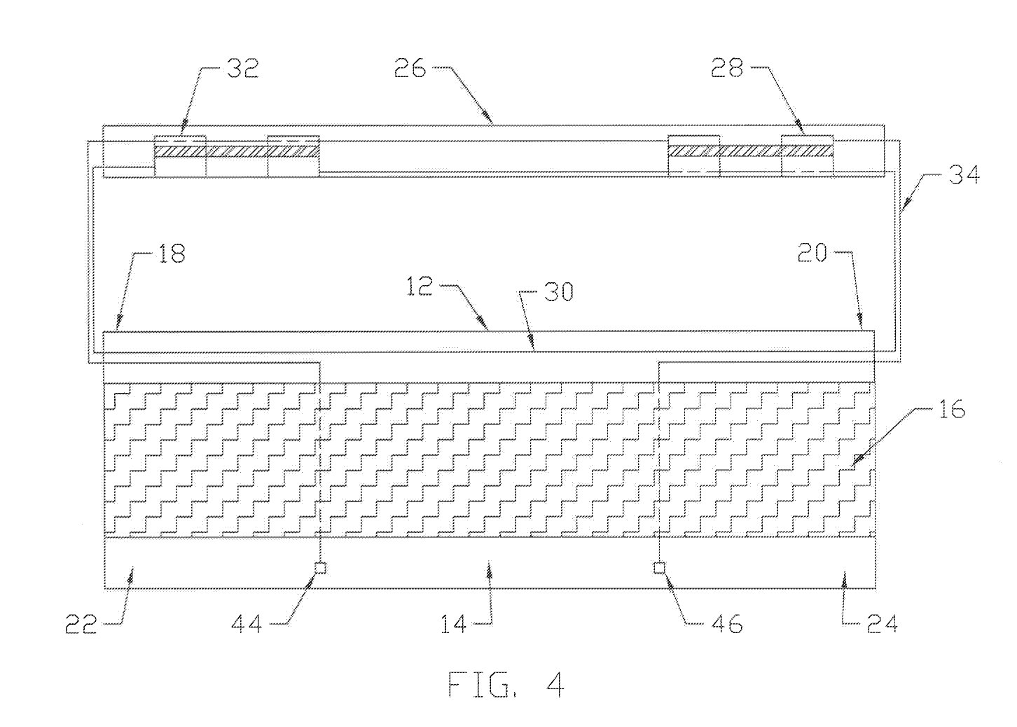

### Embodiment 4—FIG. 4

Referring to FIG. 4, embodiment 4 is an alternative to the teachings of embodiment 3 of FIG. 3. In this embodiment first member cord 30 forms an endless loop, while second member cord remains as shown in embodiment 1 of FIG. 1.

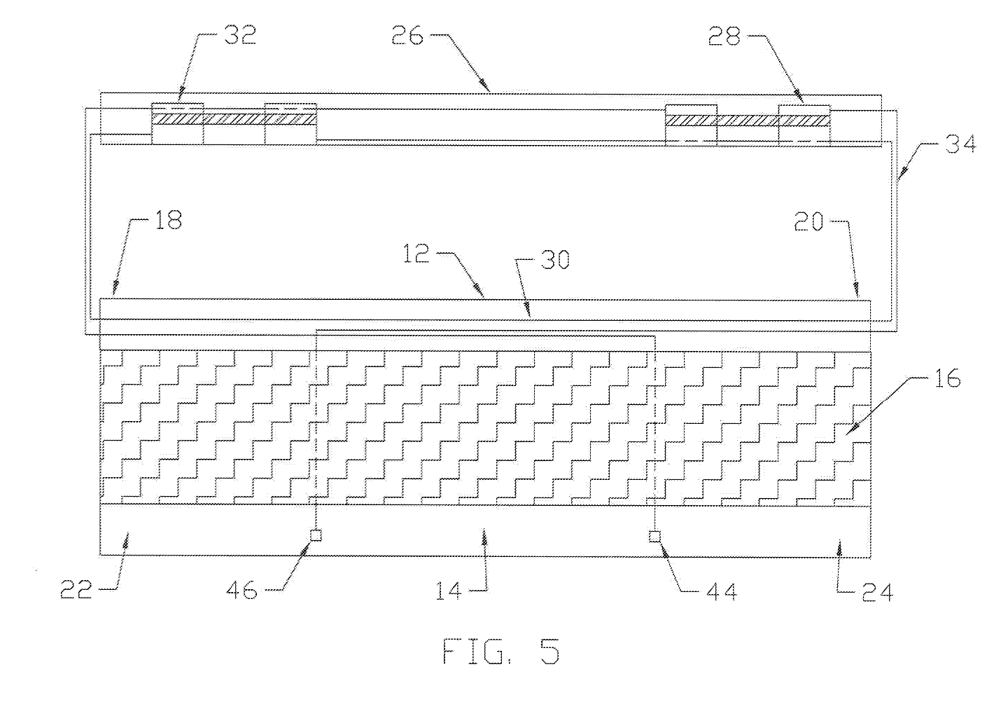

### Embodiment 5—FIG. 5

Referring to FIG. 5, embodiment 5 has first member cord 30 in the form of an endless loop as shown in embodiment 4 of FIG. 4. Second member cord 34 is the “crossed” version as shown in embodiment 2 of FIG. 2.

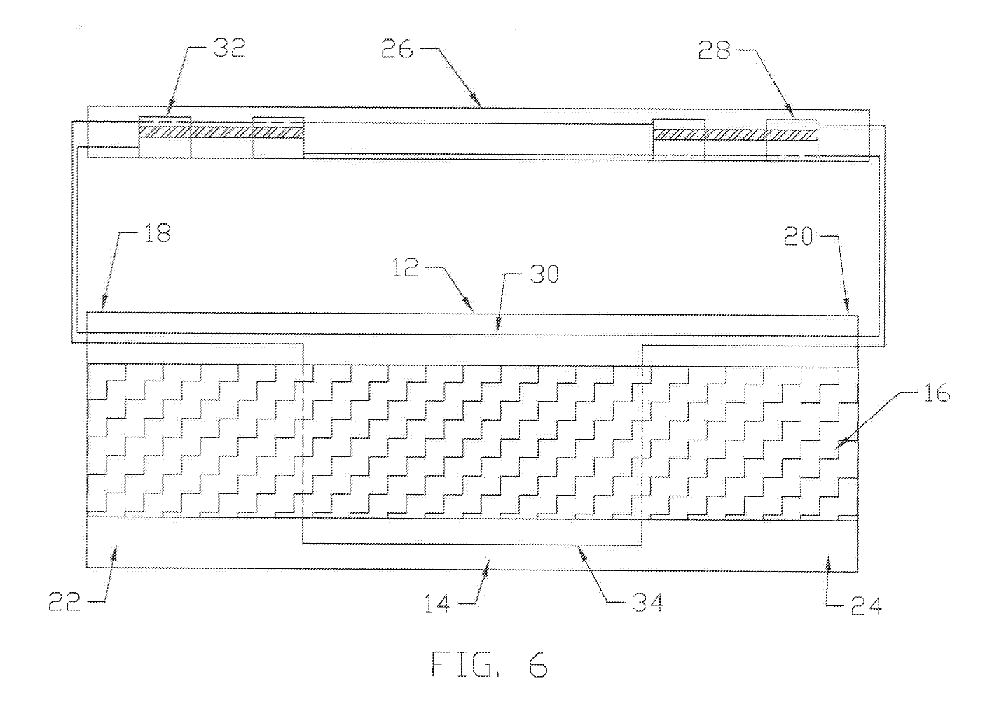

### Embodiment 6—FIG. 6

Referring to FIG. 6, embodiment 6 has first member cord 30 in the form of an endless loop as shown in embodiment 4 of FIG. 4, Second member cord 34 is also in an endless loop as shown in embodiment 3 of FIG. 3.

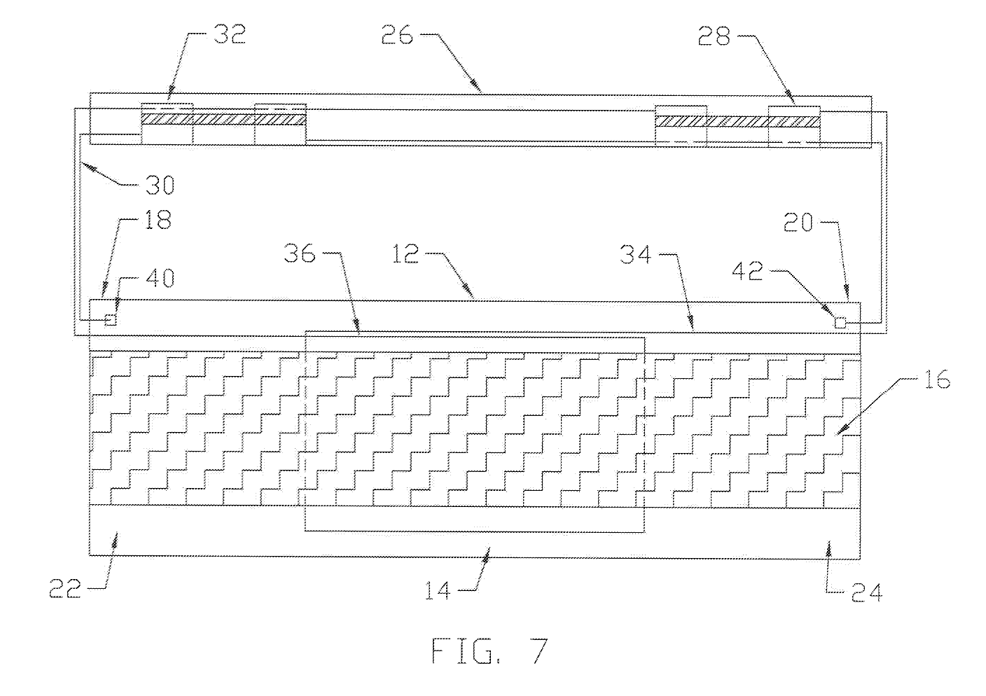

### Embodiment 7—FIG. 7

Referring to FIG. 7, embodiment 7 has first member cord 30 with ends 40 and 42 attached as previously described in relation to embodiment 1 of FIG. 1. Second member cord 34 is again in an endless loop. However, a portion 36 of the endless loop crosses over itself in a combination of the endless loop of embodiment 3 of FIG. 3 and the crossing of embodiment 2 of FIG. 2. In this embodiment endless loop of second member cord 34 enters first end 18 of first member 12, reaches a point spaced from second end 20 of first member 12, extends down through foldable blind substrate 16 to second member 14 at a point spaced from second end 24 of second member 14 and then changes direction toward first end 22 of second member 14. Similarly, endless loop of second member cord 34 enters second end 20 of first member 12, reaches a point spaced from first end 18 of first member 12, extends down through foldable blind substrate 16 to second member 14 at a point spaced from first end 22 of second member 14 and then changes direction toward second end 24 of second member 14.

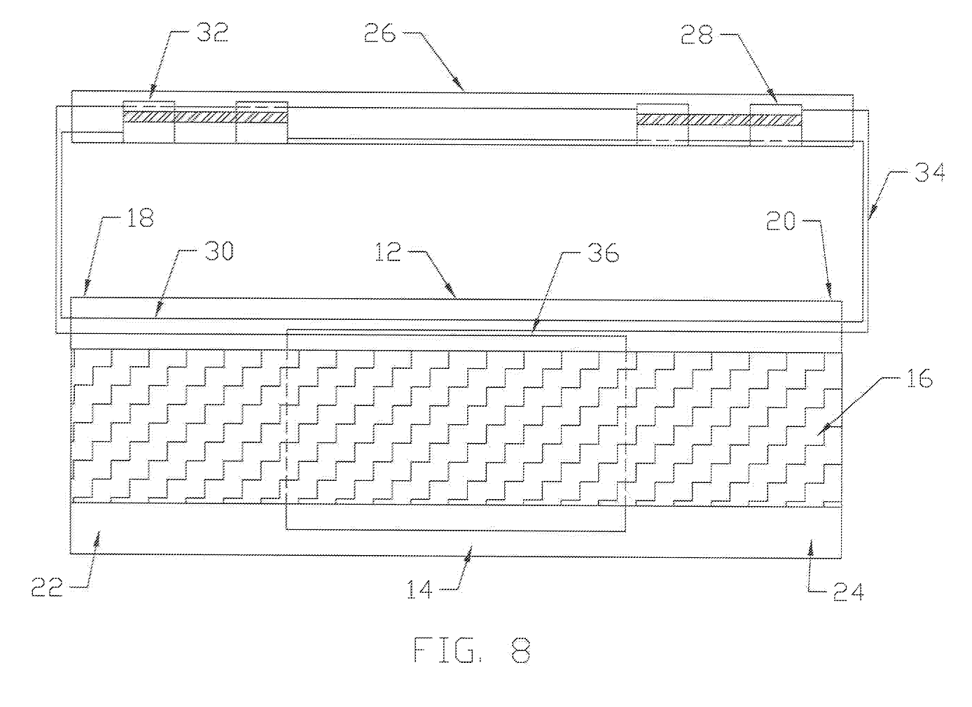

### Embodiment 8—FIG. 8

Referring to FIG. 8, embodiment 8 has first cord member 30 in an endless loop as previously described in relation to embodiment 4 of FIG. 4. Second cord member 34 is an endless loop with a portion 36 of the endless loop that crosses over itself as previously described in relation to embodiment 7 of FIG. 7.

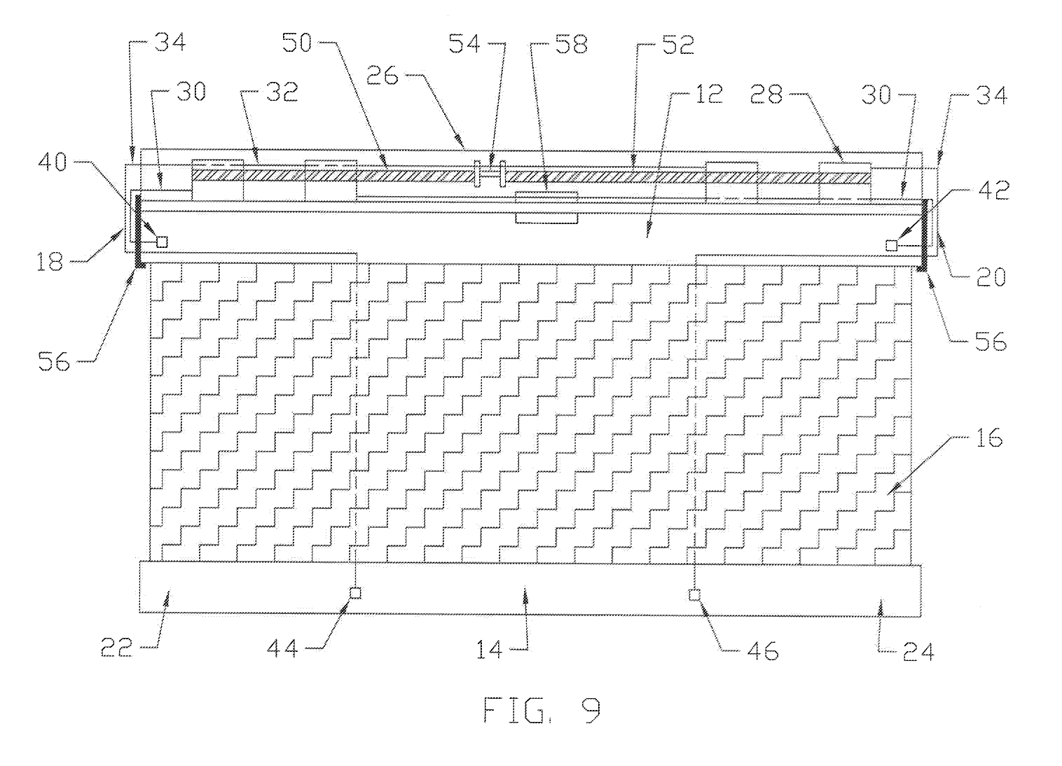

### Further Embodiments—FIG. 9

FIG. 9 shows two variations of an embodiment having the same general configuration of cords as embodiment 1 described above and shown in FIG. 1, plus a mechanical link between the first member drive unit 32 and the second member drive unit 28, the mechanical link including a first member shaft 50, a second member shaft 52, and interposed between the first member shaft 50 and the second member shaft 52, a slip clutch 54.

The slip clutch 54 is configured such that the first member shaft 50 and the second member shaft 52 tend to rotate in a corresponding manner (i.e., at the same speed and in the same direction) so as to provide for similar corresponding movement of the first member 12 and the second member 14; unless there is a pre-selected differential torsional resistance as between the first member shaft 50 and the second member shaft 52, in which event the slip clutch 54 slips, thus permitting differential relative movement of the first member shaft 50 and the second member shaft, thereby permitting differential relative movement of the first member 12 and the second member 14. In this way, a user may move the first member 12 and the second member 14 together while only touching one or the other, and a user may separately move the first member 12 and the second member 14 by manipulating each independently.

FIG. 9 also shows two variations of a retainer means for impeding movement of the first member 12 away from the drive housing 26, so as to provide the pre-selected differential torsional resistance as between the first member shaft 50 and the second member shaft 52, to cause the slip clutch 54 to slip and permit the second member 14 to move away from the first member 12. The two retainer means variations shown in FIG. 9 are: a pair of retaining hooks 56 and a magnetic coupling 58. The retaining hooks 56 are J-hooks, each having the top of the J affixed to the drive housing 26 and the bottom of the J (i.e. the hook) configure to releasably interlock with an adjacent end of the first member 12. Each retaining hook 56 is resiliently flexible and is configured to release the first member 12 under relatively minimal manual three applied to the first member 12 by a user. The magnetic coupling 58 comprises two magnets, or a magnet and a magnetic metal, each affixed to a respective one of the drive housing 26 and the first member 12 so as to resist separation of the drive housing 26 and the first member 12 in a manner akin to the retaining hooks 56.

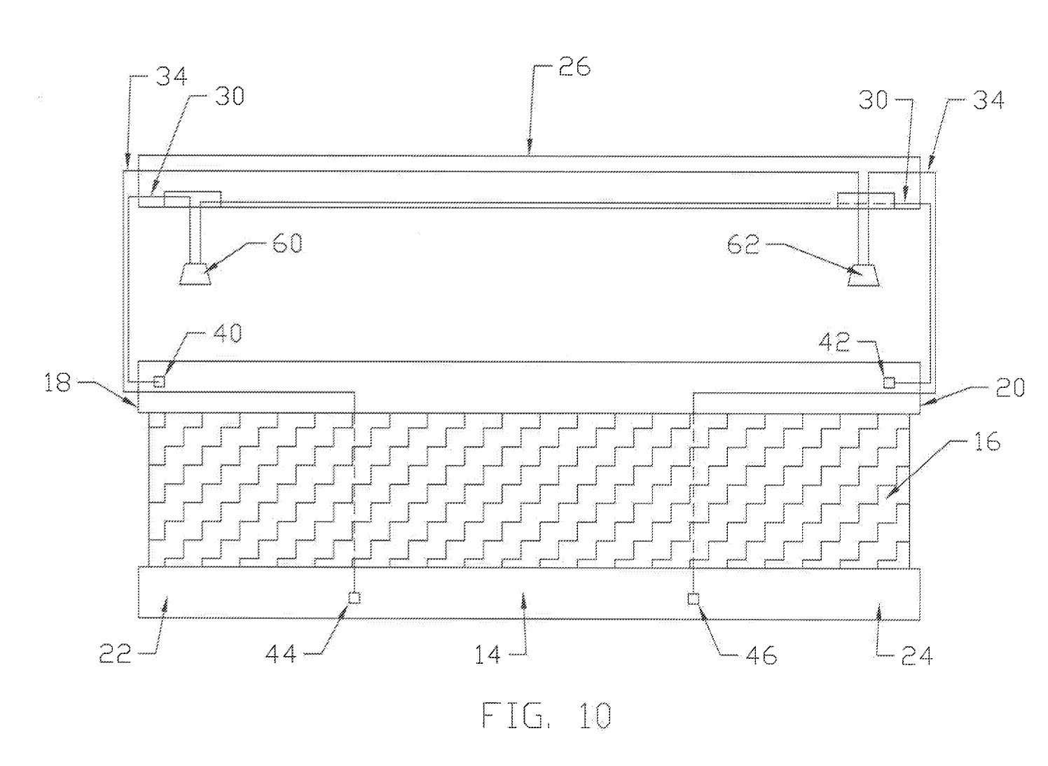

### Other Embodiment—FIG. 10

FIG. 10 discloses another embodiment having the same general configuration of cords as embodiment 1 described above and shown in FIG. 1, but having a first pull 60 instead of a first member drive unit 32 and a second pull 62 instead of a second member drive unit 28, such that a user may independently move the first member 12 and second member 14, by manipulation of the first pull 60 and second pull 62, respectively.

### Conclusion

Although embodiment 1 of FIG. 1 is a workable embodiment, the window blinds operate better if one of the other embodiments is used to assist in creating equal pull along the left side and the right side. As described, this can be done with a “crossed” approach, an endless loop approach, an endless loop that is crossed and various combinations described and illustrated above.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A drop down window blind, comprising:
a first member having opposed ends;
a second member having opposed ends, the second member being disposed on a common plane with the first member;
a foldable blind substrate connected to the first member and the second member, the blind substrate unfolding during relative diverging movement of the first member and the second member, the blind substrate folding during relative converging movement of the first member and the second member;
a drive housing which houses at least one first member drive unit;
a first member cord extending from the at least one first member drive unit through each of the opposed ends of the first member, rotation of the first member drive unit in a first rotational direction decreasing a length of the first member cord to move the first member in a first vertical direction and rotation of the first member drive unit in a second rotational direction increasing a length of the first member cord to move the first member in a second vertical direction.

2. The drop down window blind of claim 1, wherein a first end of the first member cord enters and is secured to a first of the opposed ends of the first member and a second end of the first member cord enters and is secured to a second of the opposed ends of the first member.

3. The drop down window blind of claim 1, wherein the drive housing houses at least one second member drive unit, a second member cord extending from the at least one second member drive unit through each of the opposed ends of the first member and down through the foldable blind substrate to the second member, rotation of the second member drive unit in a first rotational direction decreasing a length of the second member cord to move the second member in a first vertical direction and rotation of the second member drive unit in a second rotational direction increasing a length of the second member cord to move the second member in a second vertical direction.

4. The drop down window blind of claim 3, wherein a first end of the second member cord enters a first of the opposed ends of the first member, extends down through the foldable blind substrate and attaches at a point spaced from a first of the opposed ends of the second member and a second end of the second member cord enters a second of the opposed ends of the first member, extends down through the foldable blind substrate and attaches at a point spaced from a second of the opposed ends of the second member.

5. The drop down window blind of claim 3, wherein a first end of the second member cord enters a first of the opposed ends of the first member, extends down through the foldable blind substrate and attaches at a point spaced from a second of the opposed ends of the second member and a second end of the second member cord enters a second of the opposed ends of the first member, extends down through the foldable blind substrate and attaches at a point spaced from a first of the opposed ends of the second member.

6. The drop down window blind of claim 1, wherein the first member cord forms an endless loop.

7. The drop down window blind of claim 3, wherein the second member cord forms an endless loop.

8. The drop down window blind of claim 6, wherein the endless loop of the second member cord enters a first of the opposed ends of the first member, reaches a point spaced from a second of the opposed ends of the first member, extends down through the foldable blind substrate to the second member at a point spaced from a second end of the second member and then changes direction toward a first end of the second member, the endless loop of the second member cord enters the second of the opposed ends of the first member, reaches a point spaced from the first of the opposed ends of the first member, extends down through the foldable blind substrate to the second member at a point spaced from the first end of the second member and then changes direction toward the second end of the second member.
